(19) United States
(12) Patent Application Publication
(10) Pub. No.: US 2022/0185409 A1
(43) Pub. Date: Jun. 16, 2022

(54) SCOOTER WITH INTEGRATED LOCKING MECHANISM

(71) Applicant: Razor USA LLC, Cerritos, CA (US)

(72) Inventors: Terry Guo, Cerritos, CA (US); Tony Wang, Cerritos, CA (US); Jingjing Bo, Cerritos, CA (US)

(21) Appl. No.: 17/547,062

(22) Filed: Dec. 9, 2021

(30) Foreign Application Priority Data
Dec. 10, 2020 (CN) 202022942842.2

(51) Int. Cl. B62H 5/00; B62H 5/02; B62K 3/00

(52) U.S. Cl. CPC B62H 5/003; E05B 71/00; B62K 3/002; B62H 5/02

(57) ABSTRACT

A variety of scooters are disclosed. In some embodiments, a scooter can include a locking mechanism secured to an external surface of a frame of the scooter, and a locking cable at least partially retained within the frame of the scooter. The locking mechanism may include a lock core retained within a lock mount. The locking cable may inhibit access to a fastener securing the locking mechanism to the frame when the locking cable is retained within the locking mechanism.

### CROSS REFERENCE

This application claims priority under at least 35 U.S.C. § 119(a) of Chinese Utility Model Patent Application No. 2020229428422, filed Dec. 10, 2020, the entirety of which is incorporated by reference herein.

### BACKGROUND

### Field

This disclosure generally relates to personal mobility vehicles, such as scooters.

### Description of Certain Related Art

The use of scooters has become a popular recreational activity as well as useful means of personal transportation. Scooters have become popular among many age groups and there are many different scooter variations and scooter designs. Scooters can have at least two wheels and a steering mechanism. To ride the scooter, a user typically stands on a deck of the scooter and holds onto the steering mechanism. To propel the scooter, a user may keep one foot on the scooter deck and, with the other foot, push off from the ground to force the scooter forward.

When not in use, and when the scooter cannot be practically brought with the rider, a scooter may be left at a temporary storage location, such as a storage rack outside of a building. To prevent theft of a scooter left at a storage location, a user may utilize a separately purchased lock, such as a cable lock, to retain the scooter in place at the storage location until the rider can return and retrieve the scooter.

In some embodiments, scooters may include a locking mechanism internally integrated into the structure of the scooter itself. However, such an arrangement requires a modification of the structure of the scooter itself, increasing the complexity of the manufacturing process. In addition, such modification can weaken the overall strength of the scooter frame. If a locking mechanism internally integrated into the structure of the scooter becomes damaged, repair can be difficult and impractical.

### SUMMARY OF CERTAIN FEATURES

In one broad aspect, a scooter is provided, the scooter including a frame including a handlebar assembly, an integrated locking mechanism, including a lock fixedly secured to an exterior surface of the handlebar assembly, and a locking cable extending through a cable aperture in the frame, the locking cable secured at a first end within the frame and configured to be secured at a second end to the lock.

The handlebar assembly can include a hollow downtube. The cable aperture can extend through a portion of the downtube, and the cable aperture can be located closer to a base of the frame than the lock. The lock can include a lock mount secured to the frame, and a lock core retained within the lock mount. The locking cable includes a cable retention structure at or adjacent the first end of the locking cable, the cable retention structure having a diameter larger than a diameter of the cable aperture.

The lock can be fixedly secured to the exterior surface of the handlebar assembly by at least one aperture, and access to the at least one aperture can be inhibited by the locking cable when the second end of the locking cable is retained within the lock. The locking cable can be translatable along at least a portion of its length through the through the cable aperture to vary a length of an exposed section of the locking cable extending from the cable aperture

In another broad aspect, a scooter is provided, the scooter including a frame including at least one tubular section, a lock mount secured to the least one tubular section, a lock core retained within the lock mount, and a locking cable including a free end extending from an aperture in the at least one tubular section and configured to be releasably secured in the lock core through at least one cable aperture in the lock mount.

The lock core can include a control mechanism configured to control the retention of the free end of the locking cable, and the control mechanism can be accessible through at least one control aperture in the lock mount. The at least one control aperture can be distinct from the at least one cable aperture. The lock core can include a combination lock, and the control mechanism can include a plurality of rotatable control elements.

The scooter can additionally include an arcuate gasket disposed between the lock mount and the at least one tubular section of the frame. The mount can be secured to the at least one tubular section by a plurality of fasteners, each of the plurality of fasteners extending through a respective aperture in the arcuate gasket. The frame can include a handlebar assembly configured to control a rotational position of a front wheel of the scooter, and the at least one tubular section of the frame can include a downtube of the handlebar assembly.

In another broad aspect, a personal mobility vehicle is provided, the personal mobility vehicle including a frame including at least one frame section forming a part of a connection between a steering mechanism and a wheel of the personal mobility vehicle, a locking mechanism at least partially secured to the at least one frame section via a plurality of fasteners, and a locking cable including a free end extending from an aperture in the at least one frame section, where the locking mechanism is configured to retain the free end of the locking cable in the lock core, and where at least a portion of the locking cable inhibits access to at least one of the plurality of fasteners when the free end of the locking cable is retained in the in the lock core through at least one cable aperture in the locking mechanism.

A second end of the locking cable opposite the free end can be retained within the at least one frame section by a retention structure. The retention structure can include a threaded nut secured to a threaded end of the locking cable. A weight of the retention structure can assist with retraction of a portion of the locking cable into an interior of the at least one frame section.

The locking cable can include a coated cable. The personal mobility vehicle can additionally include a protective structure disposed in the aperture in the at least one frame section, the protective structure including an aperture through which the locking cable extends.

### BRIEF DESCRIPTION OF THE DRAWINGS

Certain features, aspects, and advantages of the subject matter disclosed herein are described below with reference to the drawings, which are intended to illustrate, and not to limit, the scope of the disclosure. Various features of different disclosed embodiments can be combined to form additional embodiments, which are part of this disclosure. No structures, features, steps, or processes are essential or critical; any can be omitted.

FIG. 1A illustrates a top front perspective view of an embodiment of a scooter with an integrated lock.

FIG. 1B illustrates a bottom front perspective view of the scooter of FIG. 1A.

FIG. 1C illustrates a front view of the scooter of FIG. 1A.

FIG. 1D illustrates a left-side view of the scooter of FIG. 1A, the right-side view being a substantial mirror image thereof.

FIG. 1E illustrates another left-side view of the scooter of FIG. 1A, shown with the locking cable wrapped around an object to secure the scooter in place.

FIG. 2 is a perspective view of a handlebar assembly of a scooter, the assembly including an integrated locking mechanism.

FIG. 3 is an exploded perspective view of the handlebar assembly and integrated locking mechanism of FIG. 2.

### DETAILED DESCRIPTION OF CERTAIN EMBODIMENTS

Reference will now be made in detail to the embodiments of the present technology. While numerous specific embodiments of the present technology will be described in conjunction with the alternative embodiments, it will be understood that they are not intended to limit the present technology to these embodiments. Instead, these described embodiments of the present technology are intended to cover alternatives, modifications and equivalents. Furthermore, in the following description, detailed numerous specific details are set forth in order to provide a thorough understanding of the present technology. However, it will be recognized by one of ordinary skill in the art that embodiments may be practiced without these specific details.

### Overview

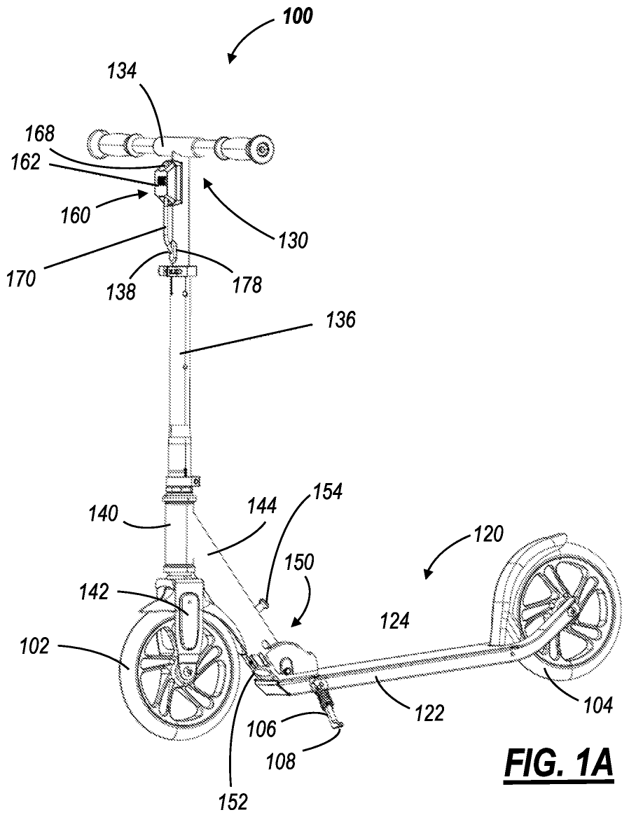

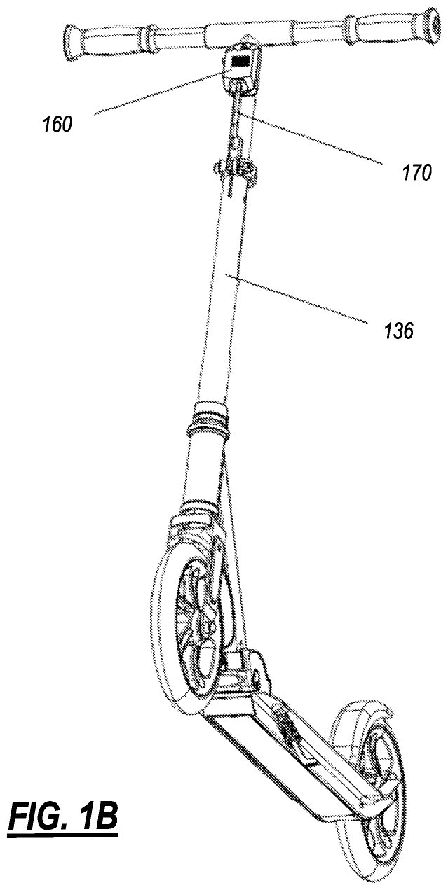

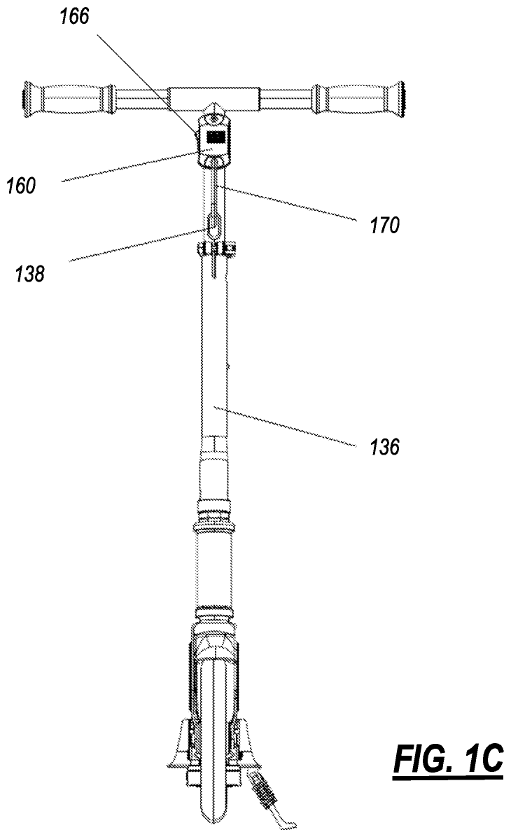

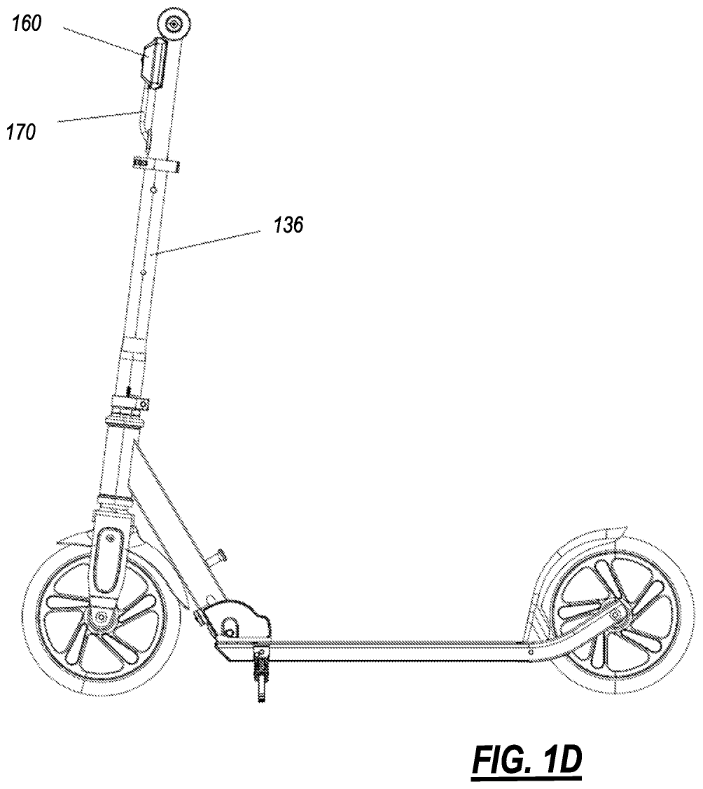

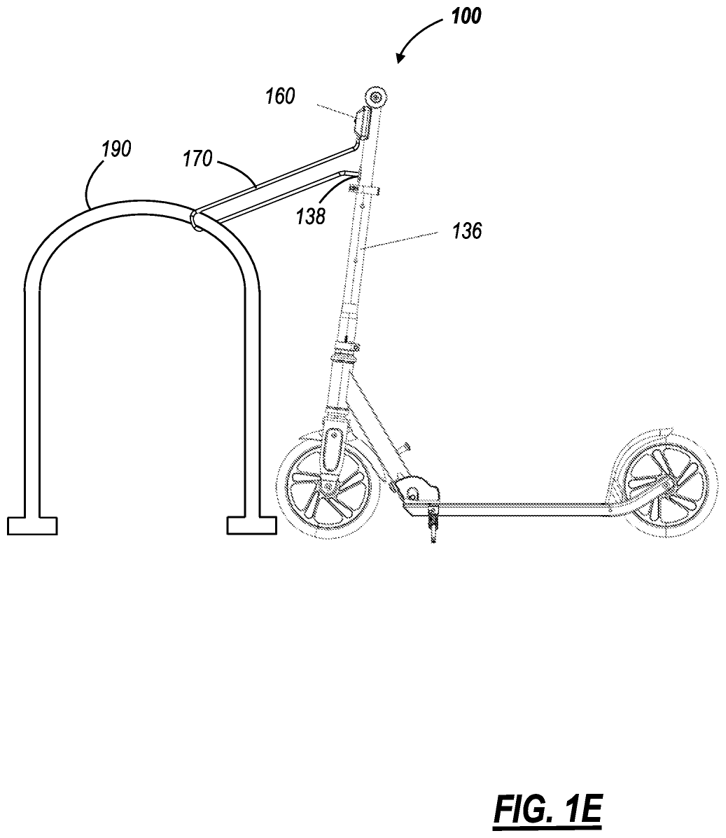

FIG. 1A shows an embodiment of a scooter having certain features, aspects and advantages of the present disclosure. The scooter 100 can include a scooter body 120. The scooter body 120 can include a deck 122 and a handlebar assembly 130. In some embodiments, the deck 122 can include an upper surface 124, which can include a footrest section which can support at least one foot or two feet of a user. In some embodiments, the upper surface 124 can support the user when the user is standing. In some embodiments, the upper surface 124 can include a gripping region, such as in the region of the footrest section. In some embodiments, the gripping region can help to inhibit or prevent slipping of the user's foot or feet.

In some embodiments, the scooter 100 can include at least one front wheel 102 and/or at least one rear wheel 104. The at least one front wheel 102 and/or the at least one rear wheel 104 can be supported by can/or connected to the scooter body 120. In some embodiments, the front wheel 102 and/or the rear wheel 104 can be spaced apart from one another with the deck 122 extending therebetween. In some embodiments, the rear wheel 104 can be connected to the deck 122. As shown, at least a portion of the rear wheel 104 can extend within at least a portion of the deck 122. In some embodiments, a rear end of the deck 122 is connected with an axle of the rear wheel 104. In some embodiments, the rear end of the deck 122 is tapered. In some embodiments, the rear end of the deck 122 is narrower than a front end of the deck 22. In some embodiments, such as the illustrated embodiment, the rear end of the deck 122 extends upwardly towards a center of the rear wheel 104, where it can support an axle of the rear wheel. In such configurations, the footrest section of the upper surface 124 can be positioned below the axle of the rear wheel. In some embodiments, the rear wheel 104 can include a rear wheel guard. The rear wheel guard can protect the rear wheel 104 from bumps, rocks, and/or dirt, among other materials. The rear wheel guard can comprise a brake. For example, the rear wheel guard can be configured to selectively contact the rear wheel 104, such as be being pivotably connected to the deck 122. The rear wheel guard can be biased out of contact with the rear wheel 104.

In some embodiments, the wheels 102, 104 can be generally aligned in the same plane when the wheels 102, 104 are in a neutral position (e.g., FIGS. 1A through 1D). In some embodiments, the wheels 102, 104 are in the neutral position when the wheels 102, 104 face in generally the same direction. In some embodiments, the wheels 102, 104 are biased to the neutral position. In some embodiments, the rear wheel 104 is fixed and/or can rotate about an axis other than the rolling axis. In some embodiments, the front wheel 102 is fixed and/or can rotate about an axis other than the rolling axis. In some embodiments, the wheels 102, 104 can be located at opposite ends of the deck 122 (e.g., near fore and/or aft regions of the scooter 100). In some embodiments, the wheels 102, 104 can include plastic, metal, and/or rubber, among other materials.

In some embodiments, the scooter 10 can include a head tube 140. The head tube 140 can rotatably support the handlebar assembly 130. In certain embodiments, the handlebar assembly 130 can rotate within the head tube 140 and/or the head tube 140 can rotate about the handlebar assembly 130.

In some embodiments, the front wheel 102 can be operatively coupled to the handlebar assembly 130 so that a user can steer the front wheel 102 by moving the handlebar assembly 130. In some embodiments, the handlebar assembly 130 can be connected to the front wheel 102 by a steering assembly having a front fork 142. In some embodiments, the front fork 142 can extend over at least a portion of the front wheel 102. For example, in some embodiments, the front fork 142 connects to an axle of the front wheel 102. Such configurations can allow the front wheel 102 to rotate within the front fork 142. In some embodiments, the front fork 142 can surround a front wheel guard. The front wheel guard can surround at least a portion of the front wheel 102. The front wheel guard can protect the front wheel 102 from bumps, rocks, and/or dirt, among other materials.

In some embodiments, a height of the handlebar assembly 130 can be adjusted by sliding one or more telescoping portions of the handlebar assembly 130 relative to one another in a direction toward or away from the deck 122.

In some embodiments, the scooter body 120 can include a support assembly 144. The support assembly 144 can connect the head tube 140 to the deck 122. In some embodiments, the support assembly 144 can extend between the head tube 140 and the deck 122. In some embodiments, the support assembly 144 can be positioned between the head tube 140 and the deck 122.

In some embodiments, the scooter 100 can include a pivot assembly 150. The pivot assembly 150 can allow the support assembly 144 and/or the head tube 140 to rotate with respect to the scooter body 120. As shown, the pivot assembly 150 can be located at the support assembly 144. In certain variants, the pivot assembly 150 can be positioned at the head tube 140 and/or the handlebar assembly 130. The pivot assembly can allow the scooter 100 to fold and/or unfold.

The support assembly 144 can have a front face that faces in a generally forward direction (e.g., towards the front wheel 102 of the scooter 100). In some embodiments, the bracket of the support assembly 144 can have a brace portion 152 that extends across the front face of the support assembly 144 and/or supports the front face, such as when the support assembly 144 can be in the unfolded configuration. The brace portion 152 can limit the amount of rotation of the support assembly 144 when rotating into an unfolded (e.g., riding) configuration. In some embodiments, the brace portion 152 can support the support assembly 144 when the scooter 100 is in the unfolded configuration.

In some embodiments, the pivot assembly 150 can include a pin extending between the support assembly 144 and the pivot assembly, and operably connected to a knob 154. In some embodiments, the pin can generally prevent the support assembly 144 from rotating toward and/or away from the deck 122 when the pin is seated. The knob 154 can be adapted to move the pin, allowing the support assembly 150 to be rotated, and the scooter 100 to be moved to a folded configuration.

As described in more detail below, the scooter 100 can include a support element 106, also referred to herein as a center stand 106 or kickstand. The center stand 106 can be mounted to the scooter body 20. In some embodiments, the center stand 106 can be mounted to a lower side of the deck 122 (e.g., underneath the footrest section of the deck 122). In some embodiments, the center stand 106 can include an foot portion 108. The ear portion 108 can extend laterally beyond the deck 122.

In certain embodiments, the scooter 100 can include at least one hand grip 132. A hand grip 132 can be disposed on each end of the handlebar assembly 130. As described in more detail below, the hand grip 132 can be ergonomically shaped, such as being generally rotationally symmetrical, among other shapes.

### Integral Locking Mechanism

In certain embodiments, an integral locking mechanism is mounted to the scooter 100. The integral locking mechanism can include a lock 160 which can be mounted to an external surface of the scooter 100. The integral locking mechanism may include a locking cable 170. The locking cable 170 can have a first end positioned within the scooter 100 and/or secured to the scooter. The locking cable 170 can have a second end which can be at positioned outside the scooter 100 and/or inserted into and retained within the lock 160. The locking cable 170 may be partially retained within an interior portion of the scooter 100. As described in more detail below, a user can remove the second end of the locking cable 170 from the lock 160, pull on the second end to extend the locking cable 170 partially out of the scooter 100, wrap the locking cable 170 around a fixed object, and secure the second end of the locking cable 170 in the lock 160, thereby securing the scooter 100 to the fixed object to deter theft.

In the illustrated embodiment, the handlebar assembly 130 of the scooter 100 includes a crossbar 134 supporting a handgrip 132 on each end, and a downtube 136. The downtube 136 can extend generally perpendicular from the crossbar 134 and be seated within the head tube 140. In some embodiments, the downtube 136 may include a plurality of sections arranged in a telescoping configuration, so that the height of the handlebar assembly 130 can be adjusted to accommodate riders of differing heights and/or to allow for more compact storage and/or transport of the scooter 100 when not being used.

The various components of the frame of the scooter 100 may include, for example hollow cylindrical tubes, although the internal and/or external cross-sections of the tubes may not be circular, and may be elliptical, rectangular, square, or any other suitable shape. In particular, the downtube 136 of the handlebar assembly 130 may include a hollow member. Hollow interiors of the various components of the frame of the scooter 100 may be used to retain, protect, and/or route various components of the scooter. For example, in embodiments in which the scooter is a powered scooter, such as an electrically powered scooter, hollow interior regions of the frame can in some embodiments be used to route power and/or control cabling.

In some embodiments, apertures may be formed in the sidewalls of hollow frame members such as downtube 136 to allow for secure mounting, or to allow wires, cables, or other components to be routed into and out of the hollow frame members. Such apertures may be formed without significant impacting the complexity of the manufacturing process or significantly impacting the resulting structural integrity of the frame members.

In the illustrated embodiment, the downtube 136 of the handlebar assembly 130 of the scooter 100 includes a cable aperture 138 extending through the sidewall of the downtube 136 and dimensioned to accommodate a locking cable 170 extending therethrough. The cable aperture 138 can include a protective structure 178 retained within or otherwise adjacent to the cable aperture 138. The protective structure 178 can in some embodiments be a bushing, grommet, or other structure, which can facilitate translation of a portion of the locking cable 170 into and out of the cable aperture 138, such as by reducing friction between the locking cable 170 and the surfaces over which it passes. Some embodiments of the scooter 100 have a single cable aperture 138 and/or do not have a plurality of cable apertures.

The locking cable 170 may include an inner core formed from a strong material, such as a metallic chain, wire, or cable. The locking cable 170 may also include an outer lining, which can be formed from a material such as plastic or rubber, to facilitate the sliding of the locking cable 170 through the cable aperture 170.

An end of the cable 170 can include a weight, such as a bolt, nut, or otherwise. The weighted end of the cable 170 can, by force of gravity, automatically tend to and/or aid in retraction of the cable 170 at least partially into the downtube 136. In other embodiments, the cable 170 is retracted by a biasing mechanism, such as a spring. In certain embodiments, after the cable 170 been secured with the lock 160, slack in the portion of the cable 170 that is outside the scooter can be partially or substantially removed due to a portion of the cable 170 being retracted into the downtube 136.

As mentioned above, the lock 160 can be mounted to an external surface of scooter 100, such as to the downtube 136. In the illustrated embodiment, the lock 160 is mounted at a location vertically aligned with and above the cable aperture 138, although other locations and arrangements of the lock 160 and the cable aperture 138 are possible in other embodiments.

The lock 160 may include one or more fasteners 168 which can securely mount the lock 160 to the downtube 136. In some embodiments, the fasteners 168 can extend into corresponding apertures in the downtube 136. In some embodiments, the fasteners 168 can extend through the downtube 136. In some embodiments, the fasteners 168 can include tamper-resistant fasteners, such as one-way screws.

In other embodiments, the lock 160 may be secured to the downtube 136 in a non-invasive fashion, such as by clamping the lock 160 around the downtube. In such an embodiment, the lock 160, or a separate clamping structure, may be secured to the downtube 136 and frictionally retained in place without the need to form any aperture or other retaining feature in the downtube 136.

By securely mounting the lock 160 to an exterior surface of the downtube 136, an integral locking mechanism may be provided in a manner which can require minimal, if any, alteration to the structure of the scooter 100. In addition, while the locking mechanism may be mounted in a manner which inhibits easy removal of the lock 160 by a potential thief when the scooter 100 is secured using the integral locking mechanism, the lock 160 can in some embodiments be removable for the purposes of repair and/or replacement.

For example, one of the fasteners 168 may be shielded or covered by a portion of the cable 170 when the locking cable 170 is retained within the lock 160, making it difficult to remove the fastener 168 without first unlocking the lock 160 and removing the retained end of the cable 170.

In other embodiments, the lock 160 may be permanently or semi-permanently attached to the downtube, such as through the use of welding or through the use of a sufficiently strong adhesive.

The locking cable 170 may be significantly longer than the visible portion of the locking cable 170 which can be seen in FIG. 1A. An additional length of the locking cable 170 may be retained within the hollow downtube 136 and/or an adjacent portion of the frame of the scooter 100 when the locking mechanism is not in use. In order to allow the locking mechanism to be used to retain the scooter relative to a scooter rack, bike rack, light pole, or other structure, the lock 160 may be operated to detach the upper end of the locking cable 170 from the lock 160, and an additional length of the locking cable 170 may be pulled through the cable aperture 138 in the downtube 136 and wrapped around an external structure before reinserting the upper end of the locking cable 170 into the lock 160, retaining the scooter in place relative to the external structure. Figure lE illustrates the scooter 100 with the locking cable 170 wrapped around an external retention structure 190, such as a bike rack or scooter rack. In conjunction with the portion of the downtube 136 extending between the lock and the cable aperture 138, the locking cable forms a loop extending around the external structure to prevent removal of the scooter 100 while the locking cable 170 is retained within the lock 160.

The lock 160 may also be used in other ways. For example, in an embodiment in which the scooter 100 comprises a folding scooter, the cable 170 may be inserted through or around another portion of the scooter 100, such as through the spokes of front or rear wheel 102, 104, to retain the scooter 100 in a folded arrangement and/or to inhibit rotation of the front or rear wheel 102, 104.

In some embodiments, the overall length of the locking cable 170 may be at least two times the length of the distance between the lock 160 and the cable aperture 138. In some embodiments, the overall length of the locking cable 170 may be at least three, four, five, six, seven, eight, nine, or times the length of the distance between the lock 160 and the cable aperture 138, although longer lengths of the locking cable 170 may also be used. In some embodiments, the overall length of the locking cable 170 may be substantially equal to the maximum extended length of the locking cable 170, although in other embodiments, the maximum extended length of the locking cable 170 may be less than the overall length of the locking cable 170, as discussed in greater detail below.

The lock 160 may in some embodiments be a combination lock. In some embodiments, the lock 160 may be a mechanical combination lock, such as a combination lock which includes a plurality of rotatable discs which can be rotated to positions indicative of an unlock code. The unlock code may be alphanumeric or otherwise indicated by writing or marking on various portions of the rotatable discs.

In other embodiments, the lock 160 may be unlockable using a key or other structure retained by the rider when the lock is being used. In other embodiments, the lock 160 may be an electronically controlled lock. For example, the lock 160 may be a lock which unlocks in response to entry of a passcode, in response to a biometric input such as a fingerprint, or through communication or interaction with an external electronic device, such as a smartphone. Any other type of lock or locking mechanism can be used in other embodiments.

In the illustrated embodiment, the lock 160 can be a combination lock in which the unlock code is entered through the rotation of a plurality of mechanical discs. When the unlock code is entered, a button 166 can be pressed to release the retained end of the locking cable 170. In other embodiments, any other suitable lock disengagement mechanism may be employed.

In the illustrated embodiment, the lock 160 may be substantially heavier than the locking cable 170 and/or will remain secured in place during operation. A scooter with a mounted lock 160 can be operated more safely than, for example, a scooter with a separate locking structure looped around or otherwise flexibly attached or secured to the scooter, where the weight of a flexibly attached lock may present a safety risk. A lock that is fixedly mounted to the scooter frame (e.g., downtube 136) can be stronger than a lock that is not mounted to the scooter frame. A lock that is fixedly mounted to an upper end of the downtube 136, such as is illustrated in FIGS. 1A-1D, can be more convenient to see and operate, compared to a lock that is not fixedly mounted to the downtube which may require the user to locate the lock and/or to bend over or stoop to operate the lock. A lock fixedly mounted to the scooter frame can enable the scooter to have only a single cable aperture 138, compared to a scooter in which the lock is not fixedly mounted and may require a plurality of cable apertures, which can reduce strength, add points of failure, complicate manufacturing, and/or otherwise be undesired.

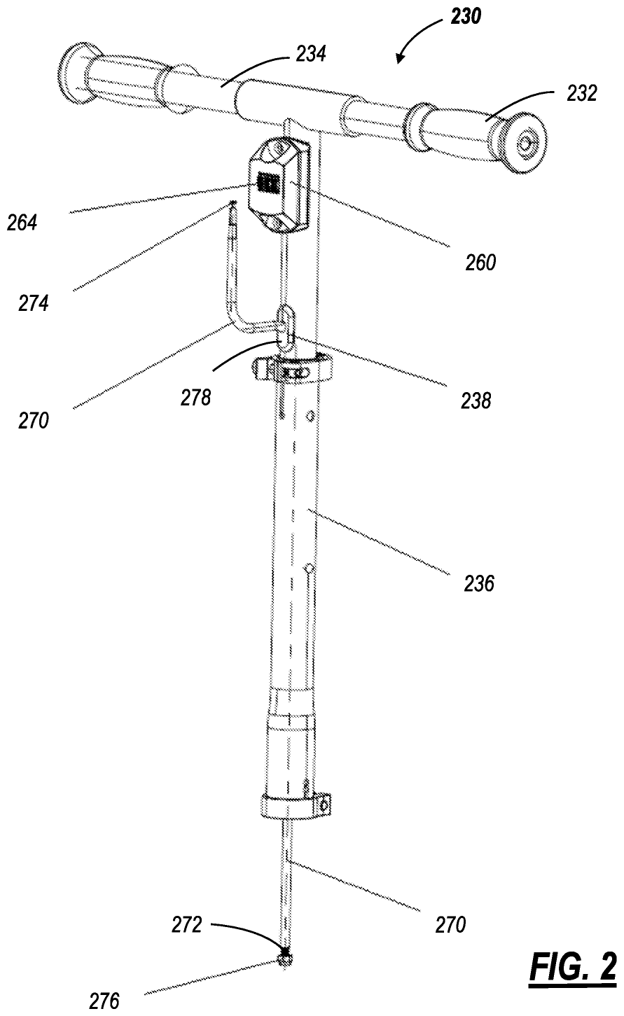

FIG. 2 illustrates an embodiment of a handlebar assembly with an integrated locking mechanism. The handlebar assembly 230 is similar to the handlebar assembly 130 of the scooter 100 of FIG. 1A, and includes a crossbar 234 supporting hand grips 232, and also includes a downtube 236 having a cable aperture 238 formed therein. A protective structure 278 is retained within or otherwise adjacent to the cable aperture 238. The lock 260 includes control features 264 configured to control the retention of the second end 274 of the locking cable 270 therein.

As can be seen in FIG. 2, only a small portion of the cable 270 extends outside of the cable aperture 238 and protection structure 278 in the handlebar assembly 230. A first end 272 of the cable 270 hangs down from the interior side of the cable aperture 238, and supports a cable retention feature 276. In the illustrated embodiment, the cable retention feature 276 includes a weighted nut or similar structure. The cable retention feature 276 has a diameter which is greater than the diameter of the cable aperture 238, so that the first end 272 of the cable 270 cannot be detached from the handlebar assembly 230 by pulling the cable 270 through the cable aperture 238.

The handlebar assembly 230 also includes a lock 260 mounted on an external surface of the handlebar assembly 230. The second end 274 of the cable 270 includes a lock engagement feature configured to be retained by the lock 260. In the illustrated embodiment, the second end 274 of the cable 270 includes an end-ball which is configured to be received within and retained by the lock 260, but any other suitable lock engagement feature may be used in other embodiments. For example, in some embodiments, the lock engagement feature at the second end 274 of the cable 270 may include a loop or hook configured to engage with a corresponding feature of the lock 260. In other embodiments, a frictional fit or crimp may be used to retain the second end 274 of the cable 270, and the outer surface of the second end 274 of the cable 270 may serve as a lock engagement feature.

In some embodiments, assembly of the handlebar assembly 270 may include inserting the cable 270 through cable aperture 238 prior to attachment of at least the cable retention feature 276 to the first end 272 of the cable 270. For example, in some embodiments, the first end 272 of the cable 270 may terminate in a threaded portion having a diameter small enough to pass through the cable aperture 238. Once pulled through, a weighted nut or other cable retention feature 276 can be attached to the first end 272 of the cable 270, such as by threading the cable retention feature 276 onto a threaded portion at the first end 272 of the cable 270.

In some embodiments, the weight of the cable retention feature 276 can provide a retraction mechanism, which can pull down on the locking cable 270 to retract the locking cable 270 or aid a user in retracting the locking cable 270 when feeding slack in the locking cable 270 back into the cable aperture 238. This can inhibit the presence of a slack loop in the locking cable 270, which could present a hazard to a user operating the scooter.

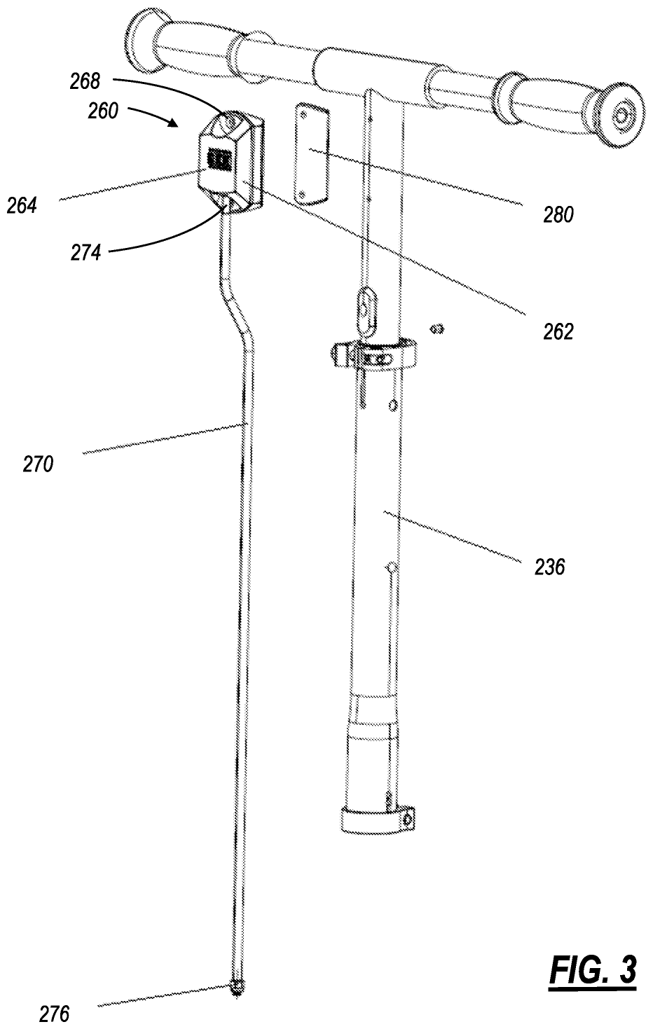

FIG. 3 is an exploded perspective view of the handlebar assembly and integrated locking mechanism of FIG. 2. As can be seen in FIG. 3, the lock 260 includes an arcuate gasket 280 or other adaptor which can be positioned between the lock 260 and a downtube 236 to facilitate mounting of a given lock to a downtube of a given size and shape, such as a downtube of a given cross-sectional diameter. In some embodiments, the arcuate gasket 280 may be dimensioned for a particular downtube 236. In other embodiments, such as embodiments in which the arcuate gasket 280 comprises a resilient material, the arcuate gasket 280 may be suitable for use with downtubes of a range of sizes and shapes, such as downtubes of a range of cross-sectional diameters.

In some embodiments, the lock 260 or other locks described herein may be an integral structure including both the lock mechanism and mounting features usable to mount the lock to an external surface of a scooter. In other embodiments, however, the lock 260 may include both a lock core and a lock housing, where the lock housing can include a receiving space for retaining a separate lock core and allowing access to the lock core. An intervening adaptor structure may be disposed between the lock housing and the lock core to allow use of a plurality of lock cores with a given lock housing.

In the illustrated embodiment the lock 260 includes a lock housing 262, with one or more apertures exposing control features 264 of a lock core retained within the lock housing 262. The lock housing 262 may include, for example, a receiving aperture (not shown) on a side of the lock housing 262 facing the mounting surface of the dimensioned to allow the entire lock core to be inserted through the receiving aperture, and one or more smaller apertures on a side of the lock housing 262 other than the side facing the mounting surface, and allowing access to control features of the lock core as well as allowing insertion and retention of the second end 274 of the locking cable 270 in the lock core. The smaller apertures are sized and/or shaped to prevent removal of the lock core therethrough when the lock housing 262 is secured relative to an external surface of the scooter.

In some embodiments, the functions of the receiving aperture and the access aperture(s) may be provided by a single contiguous aperture extending across multiple sides of the lock housing 262, where the portions of the single contiguous aperture exposed when the lock housing 262 is in a mounted position are sized and/or shaped to prevent removal of the lock core therethrough.

In the illustrated embodiment, the lock housing 262 includes two apertures 368 extending therethrough and configured to retain a fastener extending through corresponding apertures in the arcuate gasket 280 and the downtube 236. The lower of the apertures 368 will be covered by the portion of the locking cable 270 adjacent the second end 274 when the second end 274 is inserted into and retained within the lock core within lock 360. The presence of the retained portion of the locking cable 270 can protect the underlying fastener, inhibiting removal of the lock housing 262 of the lock 260 from the downtube 236 while the locking cable 270 is locked in place. In some embodiments, further features can be provided at or near the second end of the locking cable 270 to provide additional protection against access to a fastener, such as a wider collar or outwardly extending tabs near the second end 274 of the locking cable 270.

In other embodiments, other embodiments of locking mechanisms may be provided using certain of the features described herein. For example, in some embodiments, the locking cable may be permanently or semi-permanently attached to the lock, and the locking mechanism may operate by securing the lock relative to the downtube. For example, the lock may be a clamping structure which can be clamped and locked around the downtube, and unlocked to unclamp the lock from the downtube.

### Certain Terminology

Certain terminology may be used in the description for the purpose of reference only, and thus is not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may permit, the terms “approximately”, “about”, and “substantially” may refer to an amount that is within less than or equal to 10% of the stated amount. The term “generally” as used herein represents a value, amount, or characteristic that predominantly can include or tends toward a particular value, amount, or characteristic. As an example, in certain embodiments, as the context may permit, the term “generally parallel” can refer to something that departs from exactly parallel by less than or equal to 15°. Furthermore, as the context may dictate, the term “generally perpendicular” can mean something that departs from exactly, perpendicular by less than or equal to 15°. Furthermore, as the context may dictate, the term “generally aligned” can mean something that departs from exactly, aligned by less than or equal to 15°.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a device configured to carry out recitations A, B, and C” can include a first device configured to carry out recitation A working in conjunction with a second device configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### Summary

The various improvements (e.g., the integrated locking mechanism and associated details) have been disclosed in the context of certain embodiments and examples above. However, this disclosure extends beyond the specifically disclosed embodiments to other alternative embodiments and/or uses and obvious modifications and equivalents thereof. In particular, while the integrated locking mechanism has been described in the context of illustrative embodiments, certain advantages, features, and aspects of the integrated locking mechanism may be realized in a variety of other applications. Various features and aspects of the disclosed embodiments can be combined with or substituted for one another in order to form varying modes of the improvements. The scope of this disclosure should not be limited by the particular disclosed embodiments described herein.

Additionally, various aspects and features of the embodiments described can be practiced separately, combined together, or substituted for one another. A variety of combination and subcombinations of the disclosed features and aspects can be made and still fall within the scope of this disclosure. Certain features that are described in this disclosure in the context of separate implementations can also be implemented in combination in a single implementation. Conversely, various features that are described in the context of a single implementation can also be implemented in multiple implementations separately or in any suitable subcombination. Although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying drawings. The figures are drawn to scale, but such scale should not be interpreted as limiting, since dimensions and proportions other than what are shown are contemplated and are within the scope of this disclosure. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

In summary, various embodiments and examples of improvements (e.g., integrated locking mechanism for personal mobility devices, such as scooters) have been disclosed. Although the improvements have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular embodiments described above, but should be determined only by a fair reading of the claims that follow.

The following is claimed:

1. A scooter comprising:
a frame comprising a handlebar assembly;
an integrated locking mechanism, comprising:
a lock fixedly secured to an exterior surface of the handlebar assembly; and
a locking cable extending through a cable aperture in the frame, the locking cable secured at a first end within the frame and configured to be secured at a second end to the lock.

2. The scooter of claim 1, wherein the handlebar assembly includes a hollow downtube.

3. The scooter of claim 2, wherein the cable aperture extends through a portion of the downtube, and wherein the cable aperture is located closer to a base of the frame than the lock.

4. The scooter of claim 1, wherein the lock comprises:
a lock mount secured to the frame, and
a lock core retained within the lock mount.

5. The scooter of claim 1, wherein the locking cable comprises a cable retention structure at or adjacent the first end of the locking cable, the cable retention structure having a diameter larger than a diameter of the cable aperture.

6. The scooter of claim 1, wherein the lock is fixedly secured to the exterior surface of the handlebar assembly by at least one aperture, wherein access to the at least one aperture is inhibited by the locking cable when the second end of the locking cable is retained within the lock.

7. The scooter of claim 1, wherein the locking cable is translatable along at least a portion of its length through the through the cable aperture to vary a length of an exposed section of the locking cable extending from the cable aperture

8. A scooter comprising:
a frame comprising at least one tubular section;
a lock mount secured to the least one tubular section;
a lock core retained within the lock mount; and
a locking cable comprising a free end extending from an aperture in the at least one tubular section and configured to be releasably secured in the lock core through at least one cable aperture in the lock mount.

9. The scooter of claim 8, wherein the lock core comprises a control mechanism configured to control the retention of the free end of the locking cable, and wherein the control mechanism is accessible through at least one control aperture in the lock mount.

10. The scooter of claim 9, wherein the at least one control aperture is distinct from the at least one cable aperture.

11. The scooter of claim 9, wherein the lock core comprises a combination lock, and wherein the control mechanism comprises a plurality of rotatable control elements.

12. The scooter of claim 8, additionally comprising an arcuate gasket disposed between the lock mount and the at least one tubular section of the frame.

13. The scooter of claim 12, wherein the lock mount is secured to the at least one tubular section by a plurality of fasteners, each of the plurality of fasteners extending through a respective aperture in the arcuate gasket.

14. The scooter of claim 8, wherein the frame comprises a handlebar assembly configured to control a rotational position of a front wheel of the scooter, and wherein the at least one tubular section of the frame comprises a downtube of the handlebar assembly.

15. A personal mobility vehicle comprising:
a frame including at least one frame section forming a part of a connection between a steering mechanism and a wheel of the personal mobility vehicle;
a locking mechanism at least partially secured to the at least one frame section via a plurality of fasteners; and
a locking cable comprising a free end extending from an aperture in the at least one frame section, wherein the locking mechanism is configured to retain the free end of the locking cable in the lock core, and wherein at least a portion of the locking cable inhibits access to at least one of the plurality of fasteners when the free end of the locking cable is retained in the in the lock core through at least one cable aperture in the locking mechanism.

16. The personal mobility vehicle of claim 15, wherein a second end of the locking cable opposite the free end is retained within the at least one frame section by a retention structure.

17. The personal mobility vehicle of claim 16, wherein the retention structure comprises a threaded nut secured to a threaded end of the locking cable.

18. The personal mobility vehicle of claim 16, wherein a weight of the retention structure assists with retraction of a portion of the locking cable into an interior of the at least one frame section.

19. The personal mobility vehicle of claim 15, wherein the locking cable comprises a coated cable.

20. The personal mobility vehicle of claim 15, additionally comprising a protective structure disposed in the aperture in the at least one frame section, the protective structure comprising an aperture through which the locking cable extends.
